(19) United States
(12) Patent Application Publication
(10) Pub. No.: US 2008/0303954 A1
(43) Pub. Date: Dec. 11, 2008

(54) Signal Processing Apparatus, Image Display Apparatus, And Signal Processing Method

(75) Inventors: Masahiro HARAGUCHI, Daito City (JP); Takaaki ABE, Osaka City (JP); Masutaka INOUE, Hirakata City (JP); Susumu TANASE, Kadoma City (JP); Yoshinao HIRANUMA, Hirakata City (JP); Seiji TSUCHIYA, Ootsu City (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/133,069

(22) Filed: Jun. 4, 2008

(30) Foreign Application Priority Data
Jun. 4, 2007 (JP) JP2007-148547

(51) Int. Cl. H04N 5/14

(52) U.S. Cl. 348/699

(57) ABSTRACT

A signal processing apparatus 200 comprises a detection unit 221 configured to detect a motion vector in a control target area targeted for an edge-enhancement control; an extraction unit 222 configured to extract a horizontal component which is a motion vector component in a horizontal direction and a vertical component which is a motion vector component in a vertical direction, from the motion vector detected by the detection unit 221; a calculation unit 223 configured to calculate a horizontal direction enhancement amount based on an amount of the horizontal component, and to calculate a vertical direction enhancement amount based on an amount of the vertical component; and an edge-enhancement control unit 224 configured to control an edge enhancement amount for the control target area based on the horizontal direction enhancement amount and the vertical direction enhancement amount.

### CROSS REFERENCE TO RELATED APPLICATIONS

This application is based upon and claims the benefit of priority from prior Japanese Patent Application No. 2007-148547, filed on Jun. 4, 2007; the entire contents of which are incorporated herein by reference.

### BACKGROUND OF THE INVENTION

1. Field of the Invention

The present invention relates to a signal processing apparatus and an image display apparatus in both of which an edge enhancement control is performed. The present invention also relates to a signal processing method for the apparatuses.

2. Description of the Related Art

Heretofore, there has been a known image display apparatus which displays images including a static image and a dynamic image. One of the methods to get a higher image quality used in the image display apparatus is known as an edge enhancement control (sharpness control).

One of the above-mentioned image display apparatuses, which has been proposed, controls the degree of edge enhancement based on an amount of an entire motion vector (see, for example, Japanese Patent Application Publication No. 2003-69859; esp., claim 1, paragraphs [0010] and [0011], etc.).

To be more specific, the image display apparatus firstly calculates, by using a control target frame which is a frame targeted for the edge enhancement control and a reference frame which is a frame preceding the control target frame along the display-time axis, the amount of the entire so motion vector corresponding to the control target frame.

Subsequently, the image display apparatus identifies a static image area and a dynamic image area based on the amount of the entire motion vector corresponding to the control target frame. The image display apparatus applies, to the static image area, an edge enhancement degree smaller than an edge enhancement degree applied to the dynamic image area.

Thus, the above-described image display apparatus prevents from excessively applying edge enhancement degree to the static image area.

By the way, a visibility of an object moving in a horizontal direction differs from a visibility of an object moving in a vertical direction. However, the above-mentioned image display apparatus merely controls the edge enhancement degree simply based on the amount of the entire motion vector.

Therefore, the image display apparatus is not designed to consider a visibility of an object for viewers or a visual tracking ability for the moving direction of the object. Consequently, the edge enhancement control is sometimes performed inappropriately.

### SUMMARY OF THE INVENTION

An aspect of the present invention provides a signal processing apparatus. The signal processing apparatus comprises: a detection unit (a is detection unit 221) configured to detect a motion vector in a control target area targeted for an edge-enhancement control; an extraction unit (an extraction unit 222) configured to extract a horizontal component which is a motion vector component in a horizontal direction and a vertical component which is a motion vector component in a vertical direction, from the motion vector detected by the detection unit; a calculation unit (a calculation unit 223) configured to calculate a horizontal direction enhancement amount based on an amount of the horizontal component, and to calculate a vertical direction enhancement amount based on an amount of the vertical component; and an edge-enhancement control unit (an enhancement amount control unit 224) configured to control an edge enhancement amount for the control target area based on the horizontal direction enhancement amount and the vertical direction enhancement amount

According to the aspect, the calculation unit calculates the horizontal direction enhancement amount based on the amount of the horizontal so component extracted from the motion vector in the control target area. Further, the calculation unit also calculates the vertical direction enhancement amount based on the amount of the vertical component extracted from the motion vector in the control target area. The edge-enhancement control unit controls the edge enhancement amount for the control target area based on the horizontal direction enhancement amount and the vertical direction enhancement amount.

Accordingly, in the edge-enhancement control, the visual tracking ability for the moving direction (horizontal direction and vertical direction) of the object is considered. Consequently, it is possible to appropriately perform the edge-enhancement control compared to the known edge-enhancement control, which is performed simply based on the amount of the entire motion vector.

In the above-described aspect of the present invention, the calculation unit is preferably configured to calculate the horizontal direction enhancement amount by multiplying the amount of the horizontal component by a horizontal component coefficient, and to calculate the vertical direction enhancement amount by multiplying the amount of the vertical component by a vertical component coefficient, and the horizontal component coefficient and the vertical component coefficient preferably are determined so that the vertical direction enhancement amount is larger than the horizontal direction enhancement amount, when the amount of the horizontal component and the amount of the vertical component are identical.

In the above-described aspect of the present invention, the edge-enhancement control unit is preferably configured to control the edge enhancement amount for the control target area based on a correlation between the control target area and an adjacent area adjacent to the control target area.

In the above-described aspect of the present invention, the correlation between the control target area and the adjacent area is preferably a hue difference which is a difference between a hue of the target control area and a hue of the adjacent area, and the edge-enhancement control unit is preferably configured to reduce the edge enhancement amount for the control target area as the hue difference becomes larger.

In the above-described aspect of the present invention, the control so target area and the adjacent area form an identical area when the correlation between the control target area and the adjacent area is within a predetermined threshold, and the edge-enhancement control unit is preferably configured to reduce the edge enhancement amount for the control target area as the identical area becomes smaller.

In the above-described aspect of the present invention, the correlation between the control target area and the adjacent area is preferably a motion-vector correlation which is a correlation between the motion vector in the control target area and a motion vector in the adjacent area, and the edge-enhancement control unit is preferably configured to reduce the edge enhancement amount for the control target area as the motion-vector correlation becomes smaller.

In the above-described aspect of the present invention, the signal processing apparatus preferably comprises a contrast-enhancement control unit (contrast control unit 227) configured to control a contrast enhancement amount for the control target area based on a luminance of the control target area, and the contrast-enhancement control unit is preferably configured to control the contrast enhancement amount for the control target area based on the edge enhancement amount for the control target area.

In the above-described aspect of the present invention, in a case where the control target area is included in an interpolated frame which is a frame interpolated by an independent frame, the edge-enhancement control unit is preferably configured to reduce the edge enhancement amount for the control target area, as compared with the edge enhancement amount for the control target area in a case where the control target area is included in the independent frame.

An aspect of the present invention provides an image display apparatus. The image display apparatus comprises a signal processing apparatus including the above-described characteristic features.

An aspect of the present invention provided a signal processing method comprising: (a) detecting a motion vector in a control target area targeted for an edge-enhancement control; (b) extracting a horizontal component which is a motion vector component in a horizontal direction and a vertical component which is a motion vector component in a vertical direction, from the motion vector detected in the step (a); (c) calculating a horizontal direction enhancement amount based on an amount of the horizontal component, and to calculate a vertical direction enhancement amount based on an amount of the vertical component; and (d) controlling an edge enhancement amount for the control target area based on the horizontal direction enhancement amount and the vertical direction enhancement amount.

### BRIEF DESCRIPTION OF THE DRAWINGS

FIG. 1 is a diagram for showing a configuration of an image display apparatus according to a first embodiment of the present invention.

FIG. 2 is a block diagram for showing a configuration of a signal processing apparatus 200 according to the first embodiment.

FIG. 3 is a block diagram for showing a modulation-amount control unit 220.

FIG. 4 is a chart for describing a method of extracting a horizontal component, a vertical component, and a slant component according to the first embodiment.

FIGS. 5A and 5B are charts for describing an edge-enhancement amount according to a second embodiment of the present invention.

FIG. 6 is a chart for describing an edge-enhancement amount according to a third embodiment of the present invention.

FIG. 7 is a chart for describing an edge-enhancement amount according to a fourth embodiment of the present invention.

FIG. 8 is a chart for describing a correlation of a motion-vector according to a fifth embodiment of the present invention.

FIG. 9 is a block diagram for showing a modulation-amount control unit 220 according to a sixth embodiment of the present invention.

FIGS. 10A and 10B are charts for describing a contrast control according to the sixth embodiment.

FIG. 11 is a chart for describing an edge-enhancement amount according to a seventh embodiment of the present invention.

### DETAILED DESCRIPTION OF THE PREFERRED EMBODIMENTS

An image display apparatus according to embodiments of the present invention will be described below with reference to the drawings. In the descriptions of the drawings, identical or similar reference numerals are so given to identical or similar parts.

It should, however, be noted that the drawings are schematic and that the proportions among various dimensions differ from the actual ones. Accordingly specific dimensions have to be judged by taking account of the descriptions given below. In addition, note that dimensional relations or the proportions among various drawings may differ from one drawing to another.

### First Embodiment

### (Configuration of Image Display Apparatus)

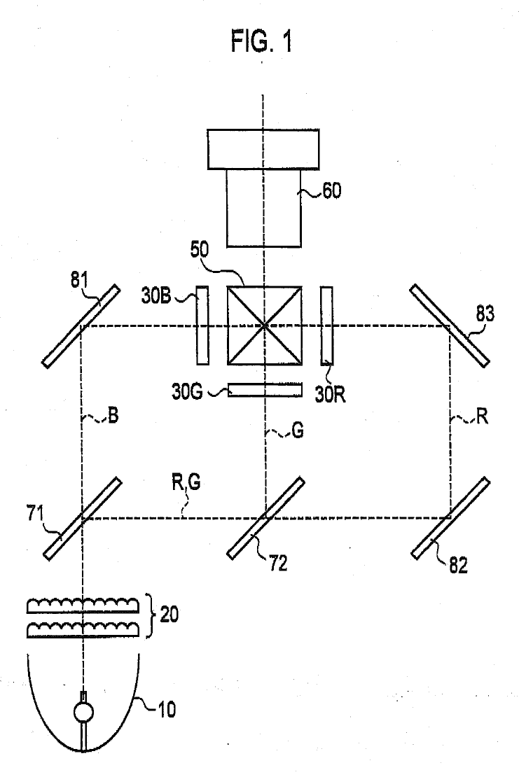

A configuration of an image display apparatus according to a first embodiment of the present invention will be described below with reference to the drawings. FIG. 1 is a diagram for showing a configuration of an image display apparatus 100 according to the first embodiment. Note that, in FIG. 1, for example, a polarized beam splitter (PBS) for controlling a polarization direction of light emitted from a light source 10 may be included.

As FIG. 1 shows, the image display apparatus 100 includes the light source 10, a fly-eye lens unit 20, plural liquid crystal panels 30 (specifically, liquid crystal panels 30R, 30G, and 30B), a cross dichroic prism 50, and a projection lens unit 60. The image display apparatus 100 utilizes a red-component light R, a green-component light G, and a blue-component light B.

The light source 10 is, for example, a UHP lamp that emits a white light. More specifically, the light emitted from the light source 10 includes, at least, the red-component light R, the green-component light G, and the blue-component light B.

The fly-eye lens unit 20 is an optical element for equalizing the white light emitted from the light source 10. More specifically, the fly-eye lens unit 20 is configured with plural microscopic lens arranged in an array. Through each of the plural microscopic lenses, three-color components included in the white light are radiated respectively onto the substantially entire surfaces of the liquid crystal panels 30 (specifically, liquid crystal panels 30R, 30G, and 30B).

The liquid crystal panel 30R modulates the red-component light R in response to an image input signal (specifically, a red input signal R). Likewise the liquid crystal panels 30G and 30B respectively modulate the green-component light G and the blue-component light B in response to the so respective image input signals (specifically, a green input signal G and a blue input signal B, respectively).

The cross dichroic prism 50 is a color combiner for combining the lights emitted from the respective liquid crystal panels 30R, 30G, and 30B. A combine light combined at the cross dichroic prism 50 is then led to the as projection lens unit 60.

The projection lens unit 60 projects the combine light combined at the cross dichroic prism 50 onto a screen (not illustrated).

As FIG. 1 shows, the image display apparatus 100 includes dichroic mirrors 71 and 72, as well as reflection mirrors 81 to 83.

The dichroic mirror 71 is a color separator for separating the white light emitted from the light source 10 into a blue-component light B for one part and a combine light, for the other part, including a green-component light G and a red-component light R.

The dichroic mirror 72 is another color separator for separating the combine light (combined the green-component light G and the red-component light R), which is separated by the dichroic mirror 71, into the green-component light G for one part and the red-component light for the other part.

The reflection mirror 81 reflects the blue-component light B separated by the dichroic mirror 71, and leads the blue-component light B to the liquid crystal panel 30B. The reflection mirrors 82 and 83 reflect the red-component light R separated by the dichroic mirror 72, and lead the red-component light R to the liquid crystal panel 30R.

### (Configuration of Signal Processing Apparatus)

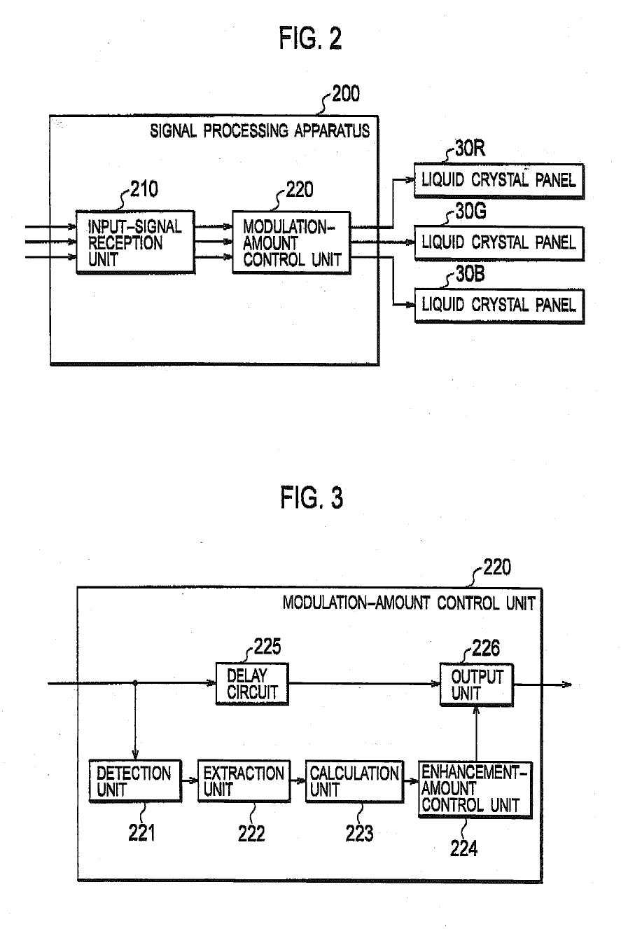

A configuration of a signal processing apparatus according to the first embodiment of the present invention will be described below with reference to the drawings. FIG. 2 is a block diagram for showing a configuration of a signal processing apparatus 200 according to the first embodiment.

As FIG. 2 shows, the signal processing apparatus 200 includes an input-signal reception unit 210 and a modulation-amount control unit 220.

The input-signal reception unit 210 receives image input signals (a red input signal R, a green input signal G, and a blue input signal B) transmitted from an external apparatus, such as a DVD player and a TV tuner.

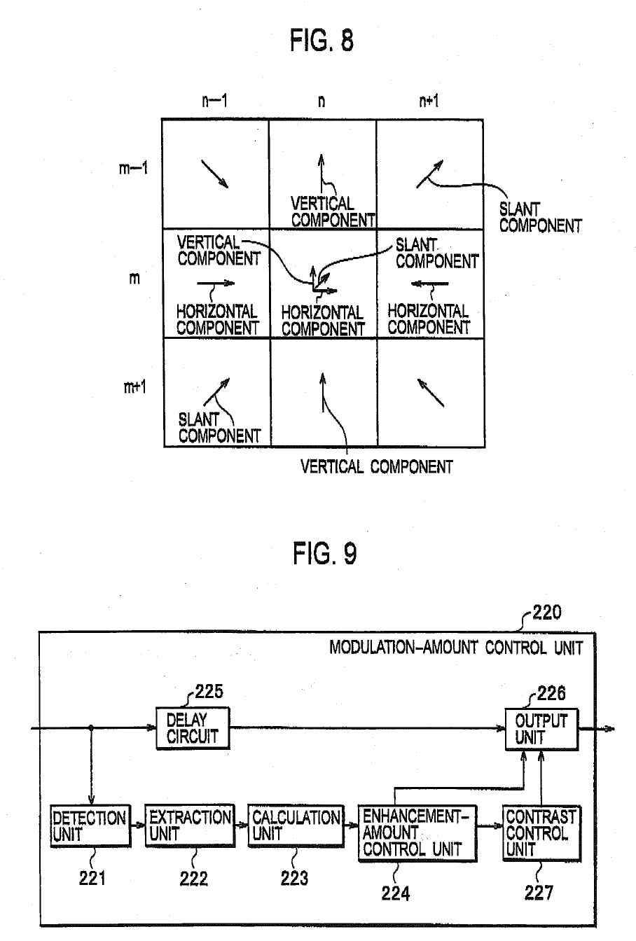

The modulation-amount control unit 220 controls modulation so amount for each liquid crystal panel 30 based on the image input signals (the red input signal R, the green input signal G, and the blue input signal B). More specifically, the modulation-amount control unit 220 includes, as FIG. 8 shows, a detection unit 221, an extraction unit 222, a calculation unit 223, an enhancement-amount control unit 224, a delay circuit 225, and an output unit 226.

The detection unit 221 detects a motion vector of an area targeted for the edge enhancement control (simply referred to as a control target area) based on plural frames (image input signals). The term “frame” used here includes not only a frame in the progressive-type scanning but also a field in the interlace-type scanning. The control target area may be either a single picture element or a block composed of plural picture elements (i.e., macroblock).

Any motion vector detection method can be employed. For example, the gradient method, the block-matching method or the like can be used for this purpose.

The extraction unit 222 extracts, from the motion vector detected by the detection unit 221, a motion vector component in the horizontal direction (the horizontal component), a motion vector component in the vertical direction (the vertical component), and a motion vector component in the slant direction (the slant component).

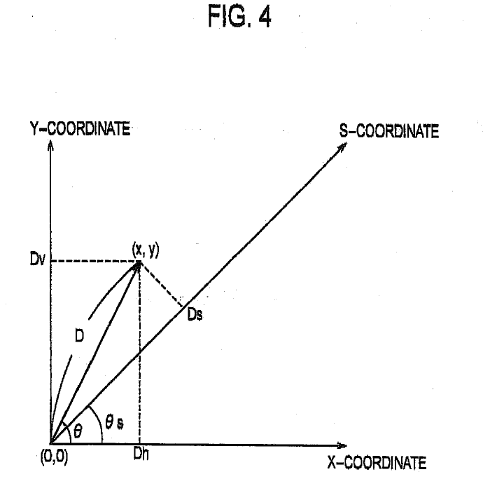

To be more specific, as FIG. 4 shows, it is supposed that a motion vector directs from the point of origin (0, 0) to a point (x, y) in the x-y coordinate. The amount of the horizontal component (Dh) is represented by the x-coordinate component of the motion vector. The amount of the vertical component (Dv) is represented by the y-coordinate component of the motion vector, while the amount of the slant component (Ds) is the s-coordinate component of the motion vector.

The s-coordinate axis is a coordinate axis that makes a predetermined angle (□s) with the x-coordinate axis. The angle (□s) can be determined arbitrarily within a range from 0° to 90° in accordance with a moving direction of a targeted object. For example, the angle (□s) that the s-coordinate axis in FIG. 4 forms with the x-coordinate axis is equal to 45°.

Assume that a motion vector has an amount (D) and an angle (□). In this case, the amount of the horizontal component (Dh), the amount of the vertical component (Dv), and the amount of the slant component (s) are so expressed by the following Formulas (1) to (3), respectively.

Dh=D×cos θ Formula (1)

Dv=D×sin θ Formula (2)

Ds=D×cos(θ−θs) Formula (3)

The calculation unit 223 calculates an enhancement amount corresponding to each direction based on the motion vector component for each direction. Note that as the motion vector component in each direction becomes larger, the enhancement amount corresponding to each direction becomes smaller.

Specifically, the calculation unit 228 calculates the horizontal direction enhancement amount (Eh) based on the amount of the horizontal component (Dh). The calculation unit 228 also calculates the vertical direction enhancement amount (Ev) based on the amount of the vertical component (Dv). Likewise, the calculation unit 223 calculates the slant direction enhancement amount (Es) based on the amount of the slant component (Ds).

The horizontal direction enhancement amount (Eh), the vertical direction enhancement amount (Ev), the slant direction enhancement amount (Es) are calculated by the following Formulas (4) to (6), respectively.

Eh=Max−k×Dh Formula (4)

Ev=Max−k×Dv Formula (5)

Es=Max−k×Ds Formula (6)

where:

Max=maximum value of the enhancement amount,

k=edge enhancement coefficient

while 0<Eh,Ev,Es<1

The enhancement-amount control unit 224 controls the edge enhancement amount (E) for the control target area based on the enhancement amounts corresponding to the respective directions (i.e., Eh, Ev, and Es). Specifically, the enhancement-amount control unit 224, firstly, calculates provisional enhancement amounts (Ph, Pv, and Ps) to be added to so the image input signal of the control target area. This calculation is based on the image input signal of the control target area and the image input signal of an adjacent area adjacent to the control target area (hereafter, simply referred to as the adjacent area). Then, the enhancement-amount control unit 224 calculates the edge-enhancement amount (E) for the control as target area based on the enhancement amounts corresponding to the respective directions (Eh, Ev, and Es) and provisional enhancement amounts corresponding to the respective directions (Ph, Pv, and Ps).

For example, the provisional enhancement amounts (Ph, Pv, and Ps) are respectively calculated by a finite impulse response filter (FIR) satisfying conditions expressed by the following Formulas (7) to (9), when the image input signal for the control target area is expressed as P_{(n, m)}.

Ph=k₁×P_{(n-1,m)}+l×P_{(n,m)}+k₂×P_{(n+1,m)} Formula (7)

Pv=k₁×P_{(n,m-1)}+l×P_{(n,m)}+k₂×P_{(n,m+1)} Formula (8)

Ps=k₁×P_{(n-1,m+1})+l×P_{(n,m)}+k₂×P_{(n+1,m-1)} Formula (9)

where:

P_{(n-1,m)} is the image input signal for the adjacent area adjacent to the left-hand side of the control target area;

P_{(n+1,m)} is the image input signal for the adjacent area adjacent to the right-hand side of the control target area;

P_{(n,m-1)} is the image input signal for the adjacent area adjacent to the top side of the control target area;

P_{(n,m+1)} is the image input signal for the adjacent area adjacent to the bottom side of the control target area;

P_{(n-1,m+1)} is the image input signal for the adjacent area adjacent to the bottom left of the control target area;

P_{(n+1,m-1)} is the image input signal for the adjacent area adjacent to the top right of the control target area;

“l” is the weighting value for the control target area; and

“k₁” and “k₂” are weighting value for the adjacent areas,

while “k₁+1+k₂=0”.

Note that “k₁” and “k₂” often have the same value. For example, in a possible case, both “k₁” and “k₂” have a value of “−0.5” while “l” has a value of “1.”

For example, the edge enhancement amount (E) for the control target area is calculated by the following formula (10).

E=Eh×Ph+Ev×Pv+Es×Ps Formula (10)

Alternatively, the edge enhancement amount (E) for the control target area may be calculated by either the formula (11) or the formula (12) given blow.

E=(Eh×Ph+Ev×Pv+Es×Ps)/3 Formula (11)

E=Min(Eh×Ph,Ev×Pv,Es×Ps) Formula (12)

Here, in Formula (11), the edge enhancement amount (E) is the average value of (Eh×Ph), (Ev×Pv), and (Es×Ps). Meanwhile, in Formula (12), the edge enhancement amount (E) is the minimum value among (Eh×Ph), (Ev×Pv), and (Es×Ps).

The delay circuit 225 is a circuit for delaying the image input signal acquired by the input-signal reception unit 210 so that the delay caused by the detection of the motion vector for the control target area and the like can be offset by the delay circuit 225. More specifically, the delay circuit 225 synchronizes the image input signal acquired by the output unit 226 from the input-signal reception unit 210 with the edge enhancement amount (E) acquired by the output unit 226 from the enhancement-amount control unit 224.

The output unit 226 adds the edge enhancement amount (E) acquired from the enhancement-amount control unit 224 to the image input signal so acquired by the delay circuit 225. Accordingly, the output unit 226 outputs, to each of the liquid crystal panels 30, an image output signal produced by adding the edge enhancement amount (E) to the image input signal acquired by the delay circuit 225.

### (Advantageous Effect)

In the signal processing apparatus 200 according to the first embodiment, the calculation unit 228 calculates the horizontal direction enhancement amount (Eh) based on the amount of the horizontal component extracted from the motion vector for the control target area. In addition, the calculation unit 223 calculates the vertical direction enhancement amount (Ev) based on the amount of the vertical component extracted from the motion vector for the control target area. Moreover, the enhancement-amount control unit 224 controls the edge enhancement amount (E) for the control target area based on the horizontal direction enhancement amount (Eh) and the vertical direction enhancement amount (Ev).

As has been described thus far, in the edge-enhancement control, the visual tracking ability for the moving direction (horizontal direction and vertical direction) of the object is considered. Consequently, it is possible to appropriately perform the edge-enhancement control compared to the known edge-enhancement control, which is performed simply based on the amount of the entire motion vector.

In addition, besides the horizontal direction enhancement amount (Eh) and the vertical direction enhancement amount (Ev), the slant direction enhancement amount (Es) is also used for the control of the edge enhancement amount (E) for the control target area performed in the first embodiment. Accordingly, it is possible to perform edge-enhancement control more appropriately.

### Second Embodiment

A second embodiment of the present embodiment will be described below with reference to the drawings. The descriptions given below are focused mainly on the difference between the above-described first embodiment and the second embodiment.

To be more specific, while the same edge enhancement coefficient (k) is used for all of the horizontal, vertical, and slant components in the first embodiment, different edge enhancement coefficients (kh, kv, and ks) are used for the horizontal, vertical, and slant components, respectively.

### (Configuration of Signal Processing Apparatus)

A configuration of a signal processing apparatus according to the second embodiment will be described below. A signal processing apparatus as 200 according to the second embodiment has a similar configuration to its counterpart according to the first embodiment.

A calculation unit 228 calculates, as in the case of the first embodiment, the enhancement amount corresponding to each direction.

For example, the horizontal direction enhancement amount (Eh), the vertical direction enhancement amount (Ev), and the slant direction enhancement amount (Es) are calculated by the following Formulas (13) to (15), respectively.

Eh=Max−kh×Dh Formula (13)

Ev=Max−kv×Dv Formula (14)

Es=Max−ks×Ds Formula (15)

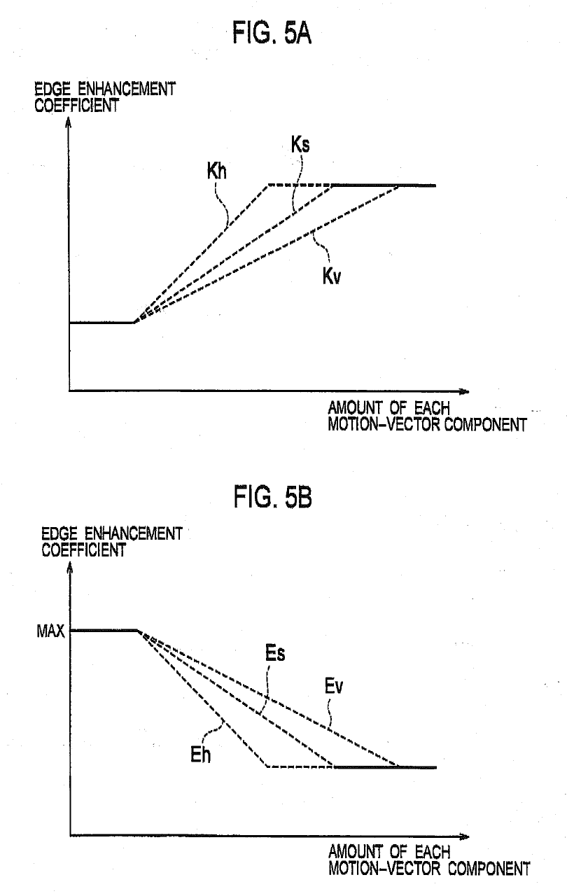

Here, as FIG. 5A shows, as the motion vector components in respective directions become larger, the values of respective edge enhancement coefficients kh, kv and ks become larger. In addition, when the motion vector components in the respective directions have the same amount, the relationship kh>ks>kv is satisfied.

Accordingly, as FIG. 5B shows, as the motion vector components in respective directions become larger, the values of respective edge enhancement coefficients Eh, Ev and Es become smaller. In addition, when the motion vector components in the respective directions have the same amount, the relationship Ev>Es>Eh is satisfied.

The above-mentioned settings are determined so as to reflect the human visual characteristics at the time of a pursuit eye movement. Specifically, it is known that the human visual tracking ability for the moving direction of the object gets higher in the order of horizontal direction, the slant direction, and the vertical direction. For more information, see Tomoko Yonemura and Sachio Nakamizo “The Effects of Pursuit Eye Movement on the Perceptual Characteristics: Study on the Aubert-Fleischl Phenomenon and Anisotropy),” The Japanese Psychological Association 68th Annual Meeting, September, 2004.

Accordingly, when the motion vector components in the respective directions have the same amount, the edge enhancement coefficients (kh, kv, and ks) are defined so that the relationship Ev>Es>Eh can be satisfied.

### (Advantageous Effect)

In the signal processing apparatus 200 according to the second embodiment, different edge enhancement coefficients (kh, kv, and ks) are used for the horizontal component, vertical component, and slant component, respectively.

As described above, the characteristics of human eyes at the time of pursuit eye movement is considered when the edge-enhancement control is performed. Accordingly, it is possible to perform the edge-enhancement control more appropriately.

Specifically, a stronger edge-enhancement control is performed for the vertical direction than for the horizontal direction, because the human visual tracking ability for the vertical direction is than that for the horizontal direction. Consequently, it is possible to perform the edge-enhancement control more appropriately.

### Third Embodiment

A third embodiment of the present embodiment will be described below with reference to the drawings. The descriptions given below are focused mainly on the difference between the above-described first embodiment and the third embodiment.

A point that is not particularly mentioned in the first embodiment is taken into account in the third embodiment. The edge enhancement amount (E) for the control target area is controlled in the third embodiment based on a hue difference i.e., a difference between a hue in the control target area and a hue in an adjacent area adjacent to the control target area.

To be more specific, as the difference between the hue of the control target area and the hue of the adjacent area (the hue difference) becomes smaller, an enhancement-amount control unit 224 strengthens the edge enhancement for the control target area. Conversely as the difference between the hue of the control target area and the hue of the adjacent area (the hue difference) becomes larger, the enhancement-amount control unit 224 weakens the edge enhancement for the control target area.

### (Configuration of Signal Processing Apparatus)

A configuration of a signal processing apparatus according to the third embodiment will be described below. A signal processing apparatus 200 according to the third embodiment has a similar configuration to its counterpart according to the first embodiment.

The enhancement-amount control unit 224 calculates the hue of the control target area and the hue of the adjacent area based on the image input signal. To be more specific, the enhancement-amount control unit 224 acquires the hues (H) of the control target area and of the adjacent area by converting from the image input signal to HSV. The hue (H) is represented in a range from 0° to 360°.

For example, the hue (H) is calculated by the following Formulas (16) to (18).

H=60×{(G−B)/(c max−c min)} Formula (16)

while R=c max

H=120+60×{(B−R)/(c max−c min)} Formula (17)

while G=c max

H=240+60×{(R−G)/(c max−c min)} Formula (18)

while B=c max
where c max=maximum (R, G, B), and c min=minimum (t, G, B).

Subsequently, the enhancement-amount control unit 224 calculates the hue differences of the respective directions (the horizontal, vertical, and slant directions).

For example, as the hue difference for the horizontal direction, the enhancement-amount control unit 224 selects the larger one of a hue difference between the control target area and an area adjacent to the right side of the control target area, and of a hue difference between the control target area and an area adjacent to the left side of the control target area.

As the hue difference for the vertical direction, the enhancement-amount control unit 224 selects the larger one of a hue difference between the control target area and an area adjacent to the top side of the control target area, and of a hue difference between the control target area and an area adjacent to the bottom side of the control target area.

As the hue difference for the slant direction, the enhancement-amount control unit 224 selects the largest one of the hue differences between the control target area and respective areas adjacent to the control target area in the slant directions.

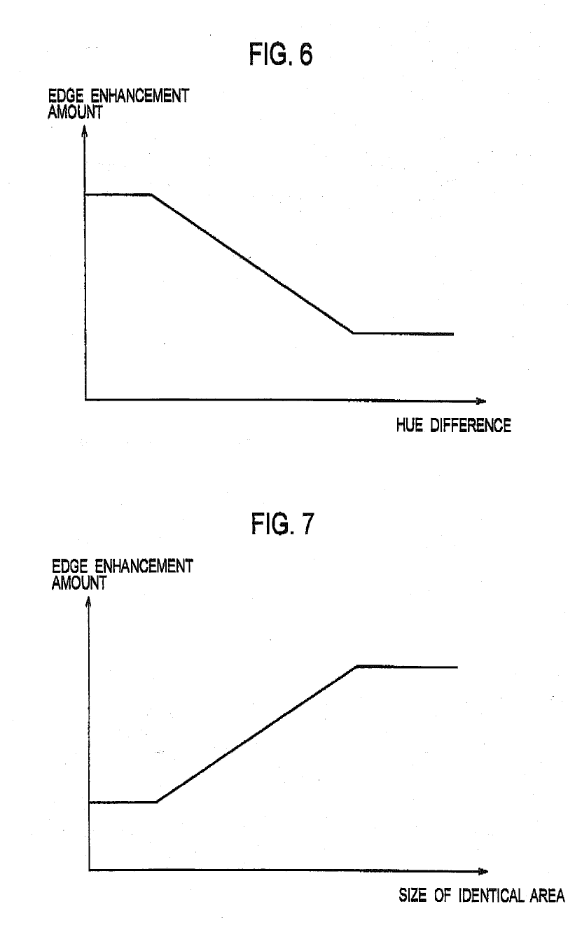

The enhancement-amount control unit 224 controls the edge enhancement amount (E) for the control target area based on the hue differences corresponding to the respective directions. To be more specific, as FIG. 6 shows, as the hue difference becomes smaller, the enhancement-amount control unit 224 strengthens the edge enhancement for the control target area. Conversely, as the hue difference becomes larger, the enhancement-amount control unit 224 weakens the edge enhancement for the control target area.

### (Advantageous Effect)

In the signal processing apparatus 200 according to the third embodiment, the enhancement-amount control unit 224 controls the edge enhancement amount (E) for the control target area based on the difference between the hue of the control target area and the hue of the adjacent area (i.e., the hue difference).

Accordingly, as the hue difference becomes larger, it is possible to prevent the enhancement of noise component caused by the excessive edge-enhancement. In addition, as the hue difference becomes smaller, it is possible to make the color border clearer.

### Fourth Embodiment

A fourth embodiment will be described below. The descriptions given below are focused mainly on the difference between the above-described first embodiment and the fourth embodiment.

A point that is not particularly mentioned in the first embodiment is taken into account in the fourth embodiment.

When the correlation between the control target area and an adjacent area (amounts of respective motion vectors, colors of respective areas, luminance of respective areas) is within a predetermined threshold, an enhancement-amount control unit 224 determines that the control target area and the adjacent area form an identical area. Subsequently, the enhancement-amount control unit 224 controls the edge enhancement amount (E) for the control target area based on the size of the identical area.

To be more specific, as the size of the identical area becomes larger, the enhancement-amount control unit 224 strengthens the edge enhancement for the control target area. Conversely, as the size of the identical area becomes smaller, the enhancement-amount control unit 224 weakens the edge enhancement for the control target area.

### (Configuration of Signal Processing Apparatus)

A configuration of a signal processing apparatus according to the fourth embodiment will be described below. A signal processing apparatus 200 according to the fourth embodiment has a similar configuration to its counterpart according to the first embodiment.

When the correlation between the control target area and an adjacent area (amounts of respective motion vectors, colors of respective areas, luminance of respective areas) is within a predetermined threshold, the enhancement-amount control unit 224 determines that the control target area and the adjacent area form an identical area. Note that the adjacent area mentioned here includes not only an area adjacent directly to the control target area but also an area adjacent to an adjacent area adjacent to the control target area.

Subsequently, the enhancement-amount control unit 224 controls the edge enhancement amount (E) for the control target area based on the size of the identical area. To be more specific, as FIG. 7 shows, as the size of the identical area becomes larger, the enhancement-amount control unit 224 strengthens the edge enhancement for the control target area. Conversely, as the size of the identical area become smaller, the enhancement-amount control unit 224 weakens the edge enhancement for the control target area.

### (Advantageous Effect)

In the signal processing apparatus 200 according to the fourth embodiment, the enhancement-amount control unit 224 controls the edge enhancement amount (E) for the control target area based on the size of the identical area.

Accordingly, as the size of the identical area, in which the correlation between the control target area and the adjacent area is within a predetermined threshold, becomes small, it is possible to prevent the enhancement of the noise component caused by the excessive edge-enhancement.

### Fifth Embodiment

A fifth embodiment of the present embodiment will be described below with reference to the drawings. The descriptions given below are focused mainly on the difference between the above-described first embodiment and the fifth embodiment.

A point that is not particularly mentioned in the first embodiment is taken into account in the fifth embodiment.

An enhancement-amount control unit 224 controls the edge enhancement amount (E) for the control target area in the fifth embodiment based on the correlation between a motion vector in the control target area and a motion vector in the adjacent area (i.e., the motion-vector correlation).

To be more specific, as the motion-vector correlation become larger, the enhancement-amount control unit 224 strengthens the edge enhancement for the control target area. Conversely, as the motion-vector correlation become smaller, the enhancement-amount control unit 224 weakens the edge enhancement for the control target area.

### (Configuration of Signal Processing Apparatus)

A configuration of a signal processing apparatus according to the fifth embodiment will be described below. A signal processing apparatus 200 according to the fifth embodiment has a similar configuration to its counterpart according to the first embodiment.

The enhancement-amount control unit 224 calculates the correlation between the motion vector components in the control target areas and the motion vector components in the adjacent area, for the respective directions (the horizontal direction, vertical direction, and slant direction).

Here, when the direction of the motion vector component in the control target area and the direction of the motion vector component in the adjacent area are the same, the enhancement-amount control unit 224 calculates the difference between these respective motion vector components. By contrast, when the direction of the motion vector component in the control target area differs from the direction of the motion vector component in the adjacent area, the enhancement-amount control unit 224 calculates the sum of the absolute values of these respective motion vector components.

There is one thing that has to be noted concerning the calculation for the motion-vector correlation. The motion-vector correlation is calculated by using the motion vector components which have the same direction as the so direction target for the calculation.

For example, suppose a case, as shown in FIG. 8, where the control target area is expressed as (m, n). For example, for the horizontal direction, the enhancement-amount control unit 224 calculates the correlation (1) between the motion vector component (the horizontal component) in the as control target area (m, n) and the motion vector component (the horizontal component) in the adjacent area (m, n−1). Here, since the directions of the two motion vector components are the same, the difference between the respective motion vectors components is calculated as “correlation (1)”.

Subsequently, the enhancement-amount calculation unit 224 calculates the correlation (2) between the motion vector component (the horizontal component) in the control target area (m, n) and the motion vector component (the horizontal component) in the adjacent area (m, n+1). Here, since the directions of the two motion vector components differ from each other, the sum of the absolute values for the two of the respective motion vector components is calculated as “correlation (2)”.

The enhancement-amount control unit 224 employs the larger one of the two correlations (1) and (2).

In addition, for the vertical direction, the enhancement-amount control unit 224 calculates the correlation between the motion vector component (the vertical component) in the control target area and the motion vector component (the vertical component) in the adjacent area, by using the same manner as the horizontal direction.

Moreover, for the slant direction, the enhancement-amount control unit 224 calculates the correlation between the motion vector component (the slant component) in the control target area and the motion vector component (the slant component) in the adjacent area, by using the same manner as the horizontal direction.

Subsequently, as the motion-vector correlation becomes larger, the enhancement-amount control unit 224 strengthens the edge enhancement for the control target area. Conversely, as the motion-vector correlation becomes smaller, the enhancement-amount control unit 224 weakens the edge enhancement for the control target area.

### (Advantageous Effect)

In the signal processing apparatus 200 according to the fifth embodiment, the enhancement-amount control unit 224 controls the edge so enhancement amount (E) for the control target area based on the correlation between the motion-vector in the control target area and the motion vector in the adjacent area.

Here, as a possible case where the correlation between motion vectors become smaller, there is a case where the moving direction of the as object in the control target area and the moving direction of the object in the adjacent area are different. Even in such case, it is possible to prevent the enhancement of the noise enhancement caused by the excessive edge-enhancement.

### Sixth Embodiment

A sixth embodiment of the present embodiment will be described below with reference to the drawings. The descriptions given below are focused mainly on the difference between the above-described first embodiment and the sixth embodiment.

A point that is not particularly mentioned in the first embodiment is taken into account in the sixth embodiment.

Besides the enhancement-amount control, a contrast control is also performed. The contrast control for the control target area is performed based on the edge enhancement amount for the control target area.

To be more specific, as the edge enhancement amount for the control target area becomes larger, the contrast control for the control target area is strengthened. Conversely, as the edge enhancement amount for the control target area becomes smaller, the contrast control for the control target area is weakened.

### (Configuration of Signal Processing Apparatus)

A configuration of a signal processing apparatus according to the sixth embodiment will be described below. FIG. 9 is a diagram for showing a configuration of a signal processing apparatus 200 according to the sixth embodiment. In FIG. 9, those constituent parts that are similar to the respective ones shown in FIG. 3 are given the same reference numerals respectively.

Besides the configuration shown in FIG. 3, the signal processing apparatus 200 shown in FIG. 9 includes a contrast control unit 227.

The contrast control unit 227 performs a contrast control for the control target area based on the luminance of the control target area. Here, so the contrast control unit 227 controls the contrast control amount based on the edge enhancement amount for the control target area.

To be more specific, as the edge enhancement amount for the control target area becomes larger, the contrast control unit 227 strengthens the contrast control for the control target area. Conversely, as the edge enhancement amount for the control target area becomes smaller, the contrast control unit weakens the contrast control for the control target area.

For example, the contrast control unit 227 performs the contrast control in the following way. Firstly, the contrast control unit 227 creates a histogram of luminance of the respective picture elements included in the control target area. The contrast control unit 227 identifies the maximum luminance included in the histogram (Hmax) and the minimum luminance included in the histogram (Hmin).

Subsequently, the contrast control unit 227 calculates the difference (SUBmax) between the maximum possible luminance (Lmax) and the maximum luminance included in the histogram (Hmax). In addition, the contrast control unit 227 calculates the difference (SUBmin) between the minimum possible luminance (Lmin) and the minimum value included in the histogram (Hmin). Calculation of the two differences (SUBmax and SUBmin) is performed by the following formulas (19).

SUB max=L max−H max

SUB min=H min−L min Formulas (19)

The contrast control unit 227 acquires the contrast enhancement coefficient (kc) based on the edge enhancement amount for the control target area. There is one thing that has to be noted here. As the edge enhancement amount for the control target area becomes larger, the contrast enhancement coefficient (kc) becomes larger.

The contrast control unit 227 calculates, by using contrast enhancement coefficient (kc), the maximum luminance after the contrast control (Cmax) and the minimum luminance after the contrast control (Cmin) by the following formulas (20) and (21), respectively.

C max=kc×SUB max+H max Formula (20)

C min=H min−kc×SUB min Formula (21)

Note that the calculation of the maximum luminance (Cmax) and the minimum luminance (Cmin) may be carried out by using only the smaller one of the above-described two differences (SUBmax and SUBmin).

Accordingly, the relationship (expressed by a curve) between the input luminance (x) and the output luminance (y) is expressed by the following formulas (22) to (24).

y=C min/H min×x

0≦x<H min Formula (22)

y=(C max−C min)/(H max−H min)×x+C min

H max≦x<L max Formula (23)

y=(L max−C max)/(L max−H max)×x+C max

H max≦x<L max Formula (24)

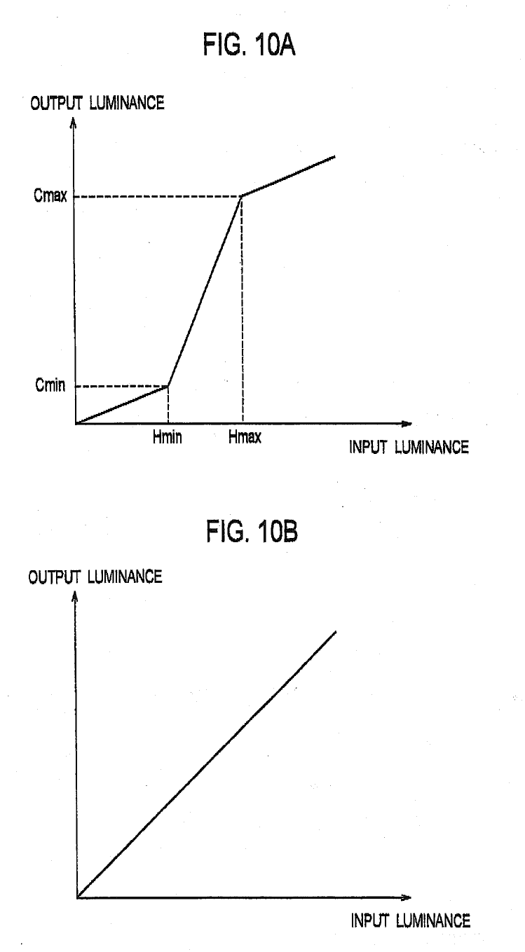

For example, when the edge enhancement amount for the control target area is larger and the contrast control for the control target area is strengthened, the relationship (curve) between the input luminance (x) and the output luminance (y) is represented by the curve shown in FIG. 10A.

Conversely, when the edge enhancement amount for the control target area is smaller and the contrast control for the control target area is weakened, the relationship (curve) between the input luminance (x) and the output luminance (y) is represented by the curve shown in FIG. 10B. Note that FIG. 10B is of a case where the contrast enhancement coefficient (kc) is equal to “zero” and that the input luminance (x) and the output luminance (y) have linearity in FIG. 10B.

In addition, an output portion 226 converts the image input signal into the image output signal by taking account of the luminance controlled by the contrast control unit 227.

### (Advantageous Effect)

In the signal processing apparatus 200 according to the sixth embodiment, the contrast control unit 227 performs the contrast control for the control target area based on the edge enhancement amount for the control target area.

Accordingly, the contrast control amount is linked with the edge enhancement amount. Consequently as the edge enhancement amount becomes larger, it is possible to increase contrast perceptual in the entire so image, since the signal processing enlarges the range of luminance. Therefore, the entire image becomes clearer as a whole. Conversely, as the edge enhancement amount becomes smaller, it is possible to prevent the enhancement of noise component.

### Seventh Embodiment

A seventh embodiment of the present embodiment will be described below with reference to the drawings. The descriptions given below are focused mainly on the difference between the above-described first embodiment and the seventh embodiment.

A point that is not particularly mentioned in the first embodiment is taken into account in the seventh embodiment.

The edge enhancement amount for the control target area is controlled based on whether the control target area is included in an interpolated frame which is a frame interpolated by an independent frame.

To be more specific, in a case where the control target area is included in an interpolated frame which is a frame interpolated by an independent frame, an enhancement control unit 224 weakens the edge enhancement for the control target area as compared with the edge enhancement for the control target area in a case where the control area is included in the independent frame.

The independent frame mentioned above is referred to a frame that is reproducible by the image input signal with no interpolation being necessary.

### (Configuration of Signal Processing Apparatus)

A configuration of a signal processing apparatus according to the seventh embodiment will be described below. A signal processing apparatus 200 according to the seventh embodiment has a similar configuration to its counterpart according to the first embodiment.

A calculation unit 223 determines whether the control target area is included in an interpolated frame, which is a frame interpolated by an independent frame. In a case where the control target area is included in the interpolated frame, the calculation unit 223 multiplies each of the values so calculated by the above-described Formulas (4) to (6) by a noise coefficient (I).

Accordingly, the horizontal direction enhancement amount (Eh), the vertical direction enhancement amount (Ev), and the slant direction enhancement amount (Es) are calculated by the following Formulas (25) to (27), respectively.

Eh=Max−l×k×Dh Formula (25)

Ev=Max−l×k×Dv Formula (26)

Es=Max−l×k×Ds Formula (27)

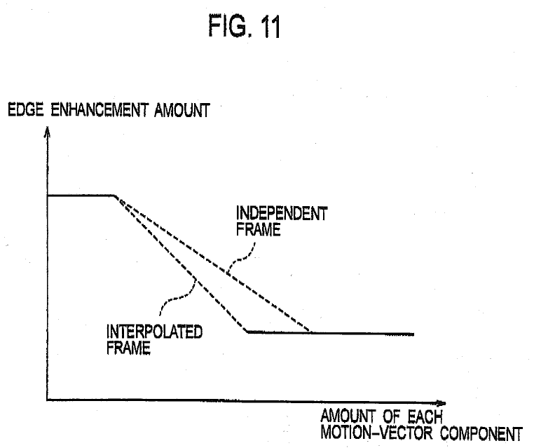

Accordingly, as FIG. 11 shows, the edge enhancement in a case where the control target area is included in the interpolated frame is made weaker than the edge enhancement in a case where the control target area is included in the independent frame.

The interpolated frame mentioned here is referred to as a frame that is interpolated by an independent frame. For instance, in an example of MPEG, a predictive frame (P-frame) and a bidirectional predictive frame (B-frame) are interpolated frames.

The independent frame, on the other hand, is a frame that is reproducible by the image input signal without interpolation. For instance, in an example of MPEG, an intra-coded frame (I-frame) is an independent frame.

Further, concerning the above-described noise coefficient (I), different noise coefficients (I) may be applied respectively to the three directions (the horizontal, vertical, and slant directions). In this case, when the motion vector components in the respective directions have the same amount, the noise coefficient for the horizontal direction (Ih), the noise coefficient for the slant direction (Is), and the noise coefficient for the vertical direction (Iv) satisfy the relationship Ih>Is>Iv.

In addition, the above-described noise coefficient (I) may vary in accordance with the interpolation amount for the interpolated frame. In this case, as the interpolation amount for the interpolated frame becomes larger, the noise coefficient (I) becomes larger.

### (Advantageous Effect)

In the signal processing apparatus according to the seventh embodiment, in a case where the control target area is included in an interpolated frame, the calculation unit 223 multiplies each of the values calculated in the respective Formulas (4) to (6) by the noise coefficient (I). More specifically, in a case where the control target area is included in the interpolated frame, the enhancement-amount control unit 224 reduces the as edge enhancement amount for the control target area as compared with the edge enhancement amount for the control target are in a case where the control target area that is included in the independent frame.

Accordingly, it is possible to prevent the excessive enhancement of noise component in an interpolated frame, in which noise component is more likely to occur.

### Other Embodiments

The present invention has been described thus far by way of the foregoing embodiments. Neither the descriptions nor the drawings that are parts of the disclosure limit the present invention. Those skilled in the art can get, from this disclosure, various ideas of alternative embodiments, examples, and application techniques.

For example, in the above-described embodiments, the edge enhancement amount (E) for the control target area is calculated using the slant direction enhancement amount (Es). This, however, is not the only possible way for such a calculation. To be more specific, the slant direction enhancement amount (Es) does not have to be used in calculating the edge enhancement amount (E).

In addition, various calculating formulas are used in the above-described embodiments. This, however, is not the only possible way for the purpose. Instead of the calculating formulas, look-up tables (LUT) in which the values are predetermined may be provided for the same purpose.

Moreover, the descriptions given in the above-described embodiments are based on a case where the image display apparatus 100 is used as an image display apparatus. This, however, is not the only possible case. To be more specific, the image display apparatus may be other types of apparatuses that are capable of displaying images (for example, a PDP, a liquid crystal TV, and the like).

There is one thing that deserves to be mentioned here though it is not so mentioned in the foregoing embodiments. Some of the first to the seventh embodiments may be combined appropriately for the purpose of carrying out the present invention.

In the sixth embodiment, the method for controlling the contrast enhancement amount based on the luminance is explained. However, the method is not limited to this. Specifically, the contrast enhancement amount may be controlled based on saturation. In this instance, it is possible to increase contrast perceptual in the entire image, since the signal processing enlarges the difference of saturation. Therefore, the entire image becomes clearer as a whole, even if an area where an effect of the contrast enhancement is low due to identical luminance is included.

What is claimed is:

1. A signal processing apparatus comprising:
a detection unit configured to detect a motion vector in a control target area targeted for an edge-enhancement control;
an extraction unit configured to extract a horizontal component which is a motion vector component in a horizontal direction and a vertical component which is a motion vector component in a vertical direction, from the motion vector detected by the detection unit;
a calculation unit configured to calculate a horizontal direction enhancement amount based on an amount of the horizontal component, and to calculate a vertical direction enhancement amount based on an amount of the vertical component; and
an edge-enhancement control unit configured to control an edge enhancement amount for the control target area based on the horizontal direction enhancement amount and the vertical direction enhancement amount.

2. The signal processing apparatus according to claim 1,
wherein the calculation unit is configured to calculate the horizontal direction enhancement amount by multiplying the amount of the horizontal component by a horizontal component coefficient, and to calculate the vertical direction enhancement amount by multiplying the amount of the vertical component by a vertical component coefficient, and
the horizontal component coefficient and the vertical component coefficient are determined so that the vertical direction enhancement amount is larger than the horizontal direction enhancement amount, when the amount of the horizontal component and the amount of the vertical component are identical.

3. The signal processing apparatus according to claim 1, wherein the edge-enhancement control unit is configured to control the edge enhancement amount for the control target area based on a correlation between the control target area and an adjacent area adjacent to the control target area.

4. The signal processing apparatus according to claim 3,
wherein the correlation between the control target area and the adjacent area is a hue difference which is a difference between a hue of the target control area and a hue of the adjacent area, and
the edge-enhancement control unit is configured to reduce the edge enhancement amount for the control target area as the hue difference becomes larger.

5. The signal processing apparatus according to claim 3,
wherein the control target area and the adjacent area form an identical area when the correlation between the control target area and the adjacent area is within a predetermined threshold, and
the edge-enhancement control unit is configured to reduce the edge enhancement amount for the control target area as the identical area becomes smaller.

6. The signal processing apparatus according to claim 3,
wherein the correlation between the control target area and the adjacent area is a motion-vector correlation which is a correlation between the motion vector in the control target area and a motion vector in the adjacent area, and
the edge-enhancement control unit is configured to reduce the edge enhancement amount for the control target area as the motion-vector correlation becomes smaller.

7. The signal processing apparatus according to claim 1 further comprising:
a contrast-enhancement control unit configured to control a contrast enhancement amount for the control target area based on a luminance of the control target area,
wherein the contrast-enhancement control unit is configured to so control the contrast enhancement amount for the control target area based on the edge enhancement amount for the control target area.

8. The signal processing apparatus according to claim 1, wherein, in a case where the control target area is included in an interpolated frame which is a frame interpolated by an independent frame, the edge-enhancement control unit is configured to reduce the edge enhancement amount for the control target area, as compared with the edge enhancement amount for the control target area in a case where the control target area is included in the independent frame.

9. An image display apparatus comprising the signal processing apparatus according to claim 1.

10. A signal processing method comprising:
(a) detecting a motion vector in a control target area targeted for an edge-enhancement control;
(b) extracting a horizontal component which is a motion vector component in a horizontal direction and a vertical component which is a motion vector component in a vertical direction, from the motion vector detected in the step (a);
(c) calculating a horizontal direction enhancement amount based on an amount of the horizontal component, and to calculate a vertical direction enhancement amount based on an amount of the vertical component; and
(d) controlling an edge enhancement amount for the control target area based on the horizontal direction enhancement amount and the vertical direction enhancement amount.
